(19) United States
(12) Patent Application Publication
(10) Pub. No.: US 2017/0061427 A1
(43) Pub. Date: Mar. 2, 2017

(54) METHOD FOR MANAGING DIGITAL WALLETS

(71) Applicant: MasterCard Asia/Pacific Pte. Ltd., Singapore (SG)

(72) Inventors: Prashant Sharma, Madison, NJ (US); Joseph Hayes, Montclair, NJ (US); Rajen Prabhu, Singapore (SG)

(21) Appl. No.: 15/241,396

(22) Filed: Aug. 19, 2016

(30) Foreign Application Priority Data
Aug. 27, 2015 (SG) 10201506781U

(51) Int. Cl. G06Q 20/36

(52) U.S. Cl. CPC G06Q 20/367; G06Q 20/363

(57) ABSTRACT

A method for managing digital wallets is provided. The method includes providing a wallet container on a computing device; identifying one or more digital wallets using a wallet locator in the wallet container for automatically identifying digital wallets for containment in the wallet container; and containerizing the one or more digital wallets into the wallet container such that the one or more digital wallets are accessible through the wallet container. The wallet container is configured to provide access to a plurality of digital wallets through the wallet container. The wallet container includes a transaction receiver for opening the wallet container upon selection of an acceptance mark in an online payment portal accessible from the computing device.

### CROSS-REFERENCE TO RELATED APPLICATION

This application is a U.S. National Stage filing under 35 U.S.C. §119, based on and claiming benefit of and priority to SG Patent Application No. 10201506781U filed Aug. 27, 2015.

### FIELD OF INVENTION

The present invention relates broadly, but not exclusively, to methods and systems for managing digital wallets.

### BACKGROUND

Over the last few decades electronic and physical transactions have increasingly involved the use of physical credit cards and the details of physical credit cards. More recently, transactions have moved towards the use of a digital or virtual wallet.

A digital wallet is typically an app on a smartphone in which a user retains information about their payment vehicle such as credit cards and bank accounts. The digital wallet is activated when making a transaction and an appropriate payment vehicle is selected from the wallet to provide funds for the transaction.

After consumer authentication, payment vehicle credentials, such as credit card number and expiry date, are sent from the digital wallet to a merchant and from the merchant to a payment gateway. And then, the payment gateway sends the payment vehicle credentials to a merchant acquirer (i.e. a bank) and onward for further processing and subsequent settlement.

There are some problems faced by consumers when setting up and using digital wallets. Since each wallet has its own features such as loyalty points or location notification, users may own several wallets. Each wallet may be linked to several payment vehicles. Thus, the more digital wallets a user owns, the more complicated is the payment procedure. Also, managing each digital wallet installed on the smartphone, such as by updating wallet credentials (e.g. user name, delivery address, billing address and categories of use such as business or personal) or updating the digital wallet itself is time-consuming.

A need therefore exists to provide methods and systems for managing digital wallets that seek to address at least the above-mentioned problems.

### SUMMARY

According to a first aspect of the present invention, a method for managing digital wallets is provided. The method includes providing a wallet container on a computing device; identifying one or more digital wallets using a wallet locator in the wallet container for automatically identifying digital wallets for containment in the wallet container; and containerizing the one or more digital wallets into the wallet container such that the one or more digital wallets are accessible through the wallet container. The wallet container is configured to provide access to a plurality of digital wallets through the wallet container. The wallet container includes a transaction receiver for opening the wallet container upon selection of an acceptance mark in an online payment portal accessible from the computing device.

According to a second aspect of the present invention, a wallet container for making a plurality of digital wallets accessible through the wallet container is provided. The wallet container is configured to be installed on a computing device. The wallet container includes a transaction receiver for opening the wallet container upon selection of an acceptance mark in an online payment portal accessible from the device. The wallet container also includes a wallet locator for automatically identifying digital wallets for containment in the wallet container.

According to a third aspect of the present invention, a system for managing digital wallets is provided. The system includes a computer. The computer includes at least one processor and at least one memory including computer program code. The at least one memory and the computer program code are configured to, with at least one processor, cause the computer at least to provide a wallet container on a computing device, identify one or more digital wallets using a wallet locator in the wallet container for automatically identifying digital wallets for containment in the wallet container; and containerize the one or more digital wallets into the wallet container such that the one or more digital wallets are accessible through the wallet container. The wallet container is configured to provide access to a plurality of digital wallets through the wallet container. The wallet container includes a transaction receiver for opening the wallet container upon selection of an acceptance mark in an online payment portal accessible from the computing device.

According to a fourth aspect of the present invention, a computer readable medium for managing digital wallets is provided. The computer readable medium includes computer program code. The computer program code is configured to, with at least one processor, cause a computer at least to provide a wallet container on a computing device, identify one or more digital wallets using a wallet locator in the wallet container for automatically identifying digital wallets for containment in the wallet container; and containerize the one or more digital wallets into the wallet container such that the one or more digital wallets are accessible through the wallet container. The wallet container is configured to provide access to a plurality of digital wallets through the wallet container. The wallet container includes a transaction receiver for opening the wallet container upon selection of an acceptance mark in an online payment portal accessible from the computing device.

Unless context dictates otherwise, the following terms will be given the meaning provided here:
“article” relates to anything that can be purchased through an electronic platform, including one of many goods and services;
“payment vehicle” includes a credit card, debit card, virtual card, bank account or any other means from which funds can be debited to affect a transaction;
“payment vehicle credentials” are any credentials necessary to affect a transaction. For a credit card, for example, the credentials may include a credit card number, account number, card or account balance, expiry date and so forth;
“acceptance mark” is a selectable mark displayed on a webpage through which a consumer can initiate a transaction from a digital wallet. Once the mark is selected (by clicking on or touching), a digital wallet is opened from which the user can select an appropriate payment vehicle with which to make the transaction;
“contained in the wallet container” refers to the property of something (such as a digital wallet) being accessible through the wallet container. In some cases, it also means that the ‘something’ (such as a digital wallet) is not accessible on a computing device except when accessed through the wallet container. A digital wallet contained in the wallet container may also refer to a digital wallet account that is accessible through the wallet container.
“outside the wallet container” means that something is installed on a computing device, however, it is not accessible through the wallet container installed on the same computing device.
“containerizing” means moving something (e.g. a digital wallet) into the wallet container such that it is contained in the wallet container. The digital wallet information and payment vehicle credentials will then be available from the wallet container so that an online payment transaction can be conducted through the wallet container. A digital wallet may be entirely containerized in the wallet container, or may be partially containerized (e.g. where two or more payment vehicles are contained in a digital wallet, one or more payment vehicles may be accessible from within the wallet container, or when making transactions through the wallet container, and one or more payment vehicles may only be accessible outside the wallet container such as through a digital wallet account).
“related digital wallet” refers to a digital wallet associated with a particular payment vehicle, such that the payment vehicle is appropriate to register or provision into that digital wallet. For example, where a payment vehicle has been issued by a particular issuer bank, a related digital wallet may be a digital wallet provided by that issuer bank, or the payment scheme intermediary between the consumer or consumer's bank, and the issuer bank. The related digital wallet may also be a digital wallet provided by the consumer's bank through which the payment vehicle was obtained.
“online payment portal” refers to a payment gateway, payment webpage or checkout process in which a user may enter credit card or payment vehicle details in order to effect an online transaction.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flow chart illustrating a method for managing digital wallets according to present teachings;

FIG. 2 shows a detailed workflow illustrating transactions between an interface, wallet container and wallet, according to present teachings;

FIG. 3 shows illustrative depictions of a graphical user interface (GUI) of a mobile device (e.g. smartphone) configured to perform a method according to present teachings;

FIG. 4 shows illustrative depictions of a graphical user interface (GUI) of a mobile device (e.g. smartphone) configured to perform a method according to present teachings;

FIG. 5 shows illustrative depictions of a graphical user interface (GUI) of a mobile device (e.g. smartphone) configured to perform a method according to present teachings;

FIG. 6 shows a schematic of a system for managing digital wallets according to present teachings; and

FIG. 7 shows an exemplary computing device suitable for executing the method for managing digital wallets according to present teachings.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

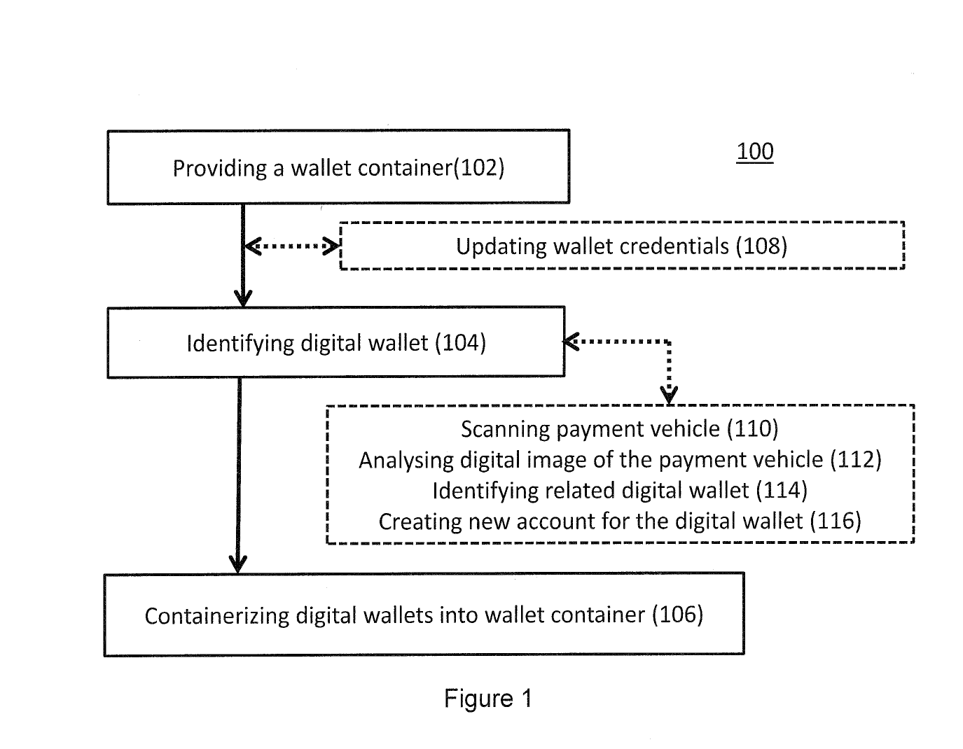

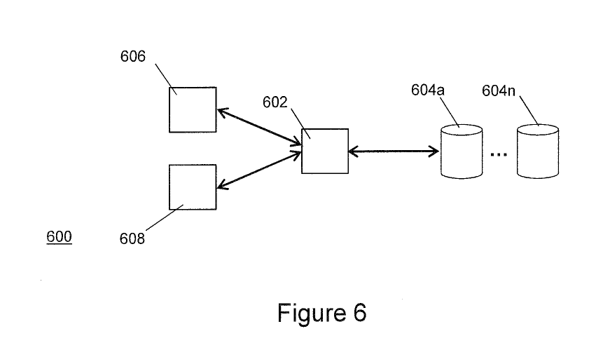

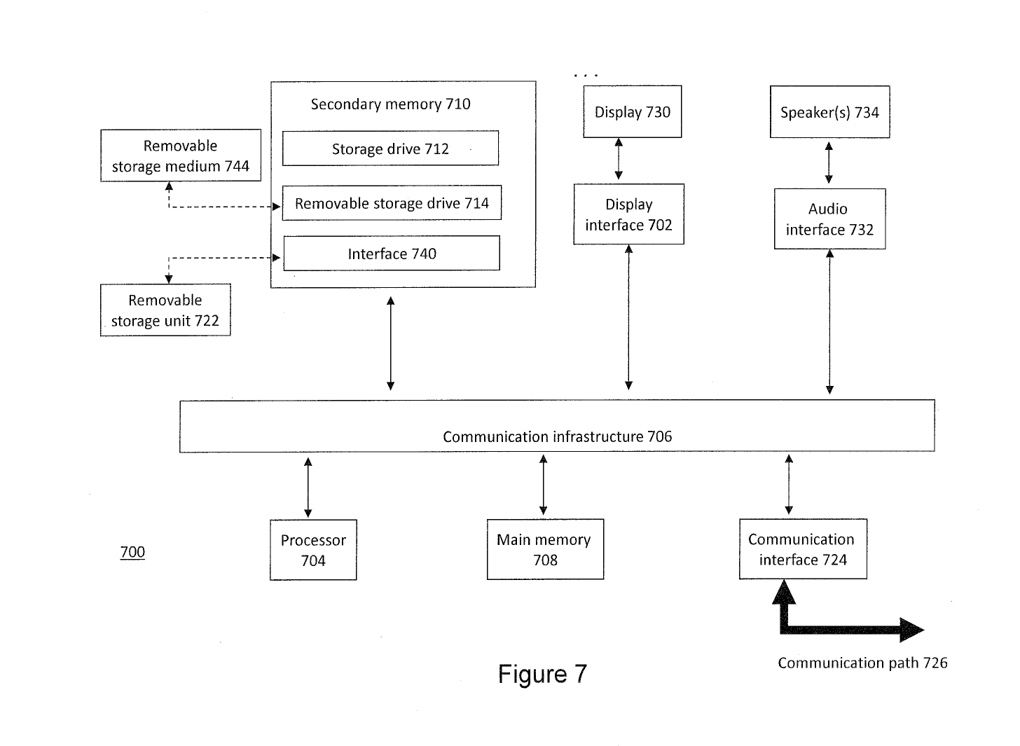

FIG. 1 shows a flow chart illustrating a method 100 for managing digital wallets, according to an embodiment of the invention. The method 100 may be performed by a computer that is coupled to one or more databases. Furthermore, the method 100 may be performed by a computing device which may be a mobile device (e.g. a smart phone or tablet computer). Further details on the computer and databases will be provided below with reference to FIGS. 6 and 7.

The method 100 broadly comprises:
Step 102: providing a wallet container for containing a plurality of digital wallets;
Step 104: identifying a digital wallet that is not contained in the wallet container; and
Step 106: containerizing the digital wallet identified at step 104.

The method 100 comprises a step 102 of providing a wallet container on a mobile device. Step 102 may comprise downloading the wallet container from the website of a digital wallet provider, from an app store or from any other suitable repository, and installing the wallet container on the mobile device. The wallet container may instead be loaded onto the mobile device directly, for example as a pre-installed app installed on the mobile device in advance of supplying the mobile device to a user.

The wallet container is configured to contain a plurality of digital wallets. The wallet container may contain a single digital wallet. However, in general, the wallet container will contain two or more digital wallets. Each digital wallet may be provided by a different issuer bank, different payment scheme or other third party digital wallet provider. Digital wallets may also be defined by purpose, for example, one digital wallet may be used for business-related transactions whereas another digital wallet may be used for personal transactions.

The wallet container may enable normal wallet functionality for the plurality of wallets. In other words, upon selection of a payment acceptance mark (e.g. Buy with MasterPass®) the wallet container may open, enabling a particular payment vehicle to be selected or, alternatively, a digital wallet to be selected from which a payment vehicle may then be selected. For those wallets contained in the wallet container, the wallet container may prevent access to those digital wallets, on the mobile device, other than through the wallet container.

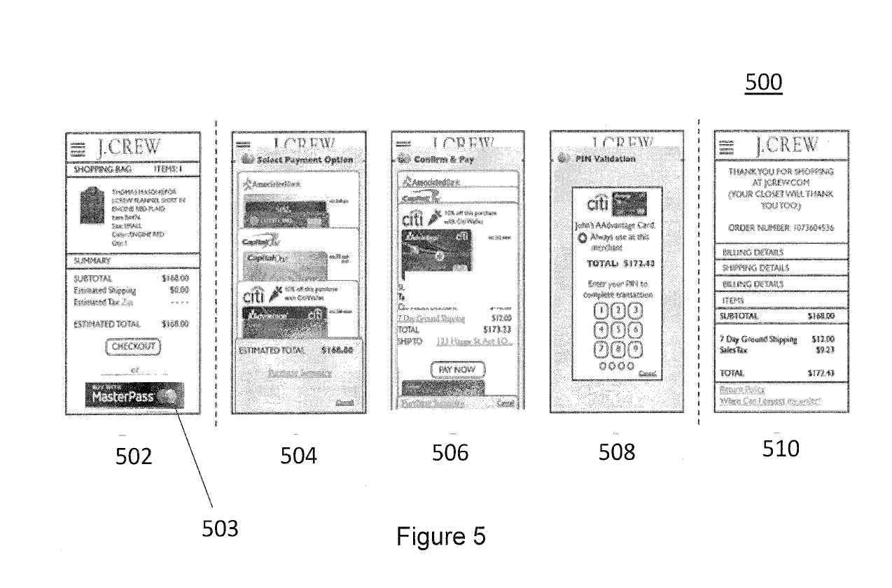

The wallet container includes a transaction receiver for opening the wallet container upon selection of an acceptance mark (e.g. Buy with MasterPass®) in an online payment portal accessible from the mobile device. Thus the transaction receiver acts as an interface between the wallet container and the online payment portal or checkout page. Upon selection of an acceptance mark during the checkout process of an online transaction, an instruction is sent (e.g. from a payment portal or payment gateway) to open the wallet container. The transaction receiver receives that instruction and opens the wallet container to make the contents of the wallet container selectable. In other words, the consumer can select an appropriate payment vehicle with which to execute the online transaction. The payment vehicle may be selectable without accessing individual wallets, or may be selectable after selection of the appropriate wallet from the wallet container. Further details on checkout process will be provided below with reference to FIG. 5.

The wallet container also includes a wallet locator for automatically identifying digital wallets for containment in the wallet container. If digital wallets are installed on a mobile device but they are not accessible through the wallet container on the mobile device, the wallet locator identifies the digital wallets by searching information on the mobile device. The searches may be a standard file or application search, or may involve a search for particular, known, types of digital wallets. The wallet locator may also search an online repository of digital wallets to identify a digital wallet for containment in the wallet container. An online repository may be a public repository or a private repository.

Step 104 involves identifying one or more digital wallets using the wallet locator. If a user has digital wallet account, the wallet locator in the wallet container identifies the relevant digital wallet on the mobile device or in an online repository. The user can then select a digital wallet from the identified digital wallets, for containment in the wallet container. The wallet locator may also perform a criteria-based search for digital wallets. In an example, a user may select a country and/or language and the wallet locator identifies digital wallets linked with the selected country and/or language. If the wallet locator uses geolocation information of the user to identify the country of the user, selection of country and/or language by user may not be required. The geolocation information may include GPS information, information of a base station for mobile communication, etc.

If a user does not have any digital wallet account, the user may create a new digital wallet account through the wallet container on the mobile device as shown in Step 110, Step 112, Step 114 and Step 116. At Step 110, the user may scan a payment vehicle such as credit card or debit card using a payment vehicle scanner coupled to the mobile device to create digital image of the payment vehicle. The payment vehicle scanner may be connected to the mobile device via earphone jack of the mobile device, a dock connector or any other port of the mobile device. The payment vehicle scanner may be coupled to the mobile device wirelessly using any type of wireless protocol such as Wi-Fi, Bluetooth or Near Field Communication (NFC). The payment vehicle scanner may be embedded on the mobile device. The payment vehicle scanner may comprise the digital camera of the mobile device. The payment vehicle scanner may comprise a magnetic stripe reader, a chip reader or any other device for scanning the card details. It should be noted that for the purpose of the present disclosure, the term “scanning” includes ‘reading’ information from a card, capturing an image of information on a card or any other process whereby electronic means are involved in obtaining or extracting information from a card or other payment vehicle.

At Step 112, the digital image of the payment vehicle is analysed by a digital image analyser to identify payment vehicle credentials of the payment vehicle. The digital image analyser may be a part of the mobile device such as software or firmware. Based on the digital image of the payment vehicle created at step 110, the digital image analyser may extract payment vehicle credentials so that the payment vehicle is digitized can be enabled for use on the mobile device. For a credit card, payment vehicle credentials may include the card number, card type, expiry date, CCV number, name of cardholder and any other details that may be relevant to effect an online transaction.

At Step 114, a related digital wallet for containing the payment vehicle is identified. Each payment vehicle must be linked with, or provisioned into, a specific wallet. The specific wallet may be fixed for a particular card or may be selected at the user's discretion. For example, a credit card issued by a bank may be linked with a wallet provided by the issuer bank. In this step, based on payment vehicle credentials extracted at Step 112, a related digital wallet is identified using the wallet locator. A plurality of digital wallets may be suggested to contain the payment vehicle so that the user may select a preferred digital wallet to create (if it is not already installed on the mobile device) or into which to provision the payment vehicle (if the wallet is already installed on the mobile device).

At Step 116, a new account for the related digital wallet is created. If the user owns an account for the related digital wallet, this step is not required. If the user does not have an account for the related digital wallet, the account for the related digital wallet is required to contain the related digital wallet into the wallet container. Once the related wallet is identified, the user may create new account for the related digital wallet through the wallet container. The account may be retained on the mobile device in association with the wallet container or may be maintained on a remote server. Where the account is retained on the mobile device, it may be visible as a new wallet in the wallet container, or may appear as one or more payment vehicles that are contained in the wallet container without any visible association with a wallet.

To the extent that creation of the new account relies on data already known to the wallet container or to one or more digital wallets within the wallet container (e.g. user name, date of birth, address) the wallet container may automatically populate the account details or even establish the account on behalf of the user. Upon creation of the wallet in the wallet container, the payment vehicle may be automatically provision into (i.e. added to) the wallet.

At Step 106, the digital wallet identified at Step 104 is containerizing into wallet container. If a new account for the digital wallet was created at Step 116, the digital wallet may be automatically added to the wallet container because the account was created through the wallet container. If the user has an account for the digital wallet and the digital wallet contains a plurality of cards, the user may select a subset of the cards for availability from the wallet when containerizing in the wallet container. In other words, containerising a digital wallet may include making only a subset of the payment vehicles in the digital wallet account accessible for transactions made through the wallet container.

Optionally, at Step 108, a global update of wallet credentials can be performed, to update credentials of all digital wallets contained in the wallet container. For example, if the user changes his/her residential address, that address can be updated for all wallets. It is thus not necessary to update the information for each digital wallet separately. The wallet container conducts a global update of wallet credentials of all digital wallets to save time for the user.

Alternatively, at Step 108, an update may be made of wallet credentials of at least one wallet from the plurality of wallets contained in the container. This can be useful where, for example, the user renews at least one of the payment vehicles and the corresponding expiry date needs to be updated. The wallet container may then update credentials of that payment vehicle and/or the related digital wallet independently of the other digital wallets and payment vehicles. Thus the wallet container provides the management functionality of a digital wallet app, for use with a plurality of digital wallets. It is therefore not necessary to for a separate app, to be installed on the mobile device, for each digital wallet.

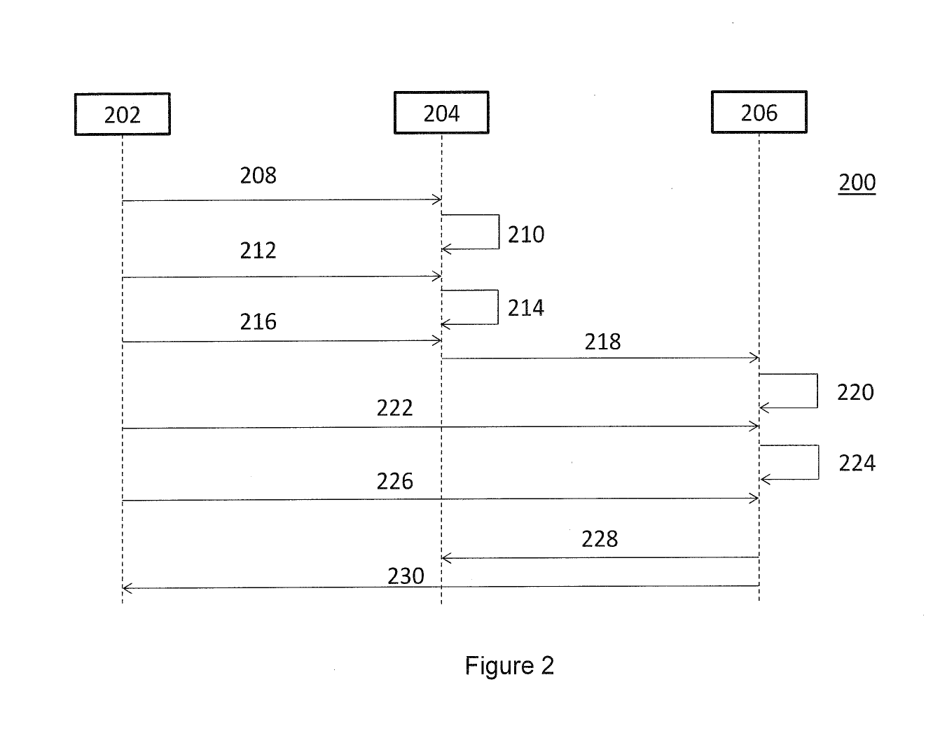

FIG. 2 shows a detailed workflow 200 illustrating transactions between interface 202, wallet container 204 and wallet 206, according to an embodiment of the invention. The workflow may be used to provision (i.e. add) a card into the wallet container. The wallet container 204 such as a MasterPass® App is pre-installed or downloaded to a mobile device. At step 208, the wallet container 204 receives instruction from interface 202 (e.g. by tapping an icon on a smartphone touch screen) to open the wallet container 204, in response to which the wallet container is opened thereby providing access to the wallet or wallets contained therein. Optionally, the wallet container 204 may employ a user authentication process at step 210 to authenticate the user in advance of opening the wallet and providing access to its contents.

At step 212, the wallet container 204 receives instruction from the interface 202 to select a payment vehicle from an existing digital wallet contained in the wallet container 204. In response to the instruction at step 212, the wallet container 204 retrieves wallet information from at least one server, or from memory accessed by the at least one server, and displays wallets contained in the wallet container 204 from which the payment vehicle can be selected, at step 214

At step 216, the wallet container 204 receives selection from the interface 202 of a wallet from the wallets displayed at step 214. The wallet container 204 instructs the selected wallet 206 to produce a login page at step 218. At step 220, the wallet 206 displays the login page in response to the instruction at step 218. At step 222, the wallet 206 receives login information from the interface 202.

At step 224, the at least one server receives the login information from the interface 202 of the mobile device and authenticates the user of the wallet 206 based on the login information. The server then causes the wallet 206 to display payment vehicles registered in the wallet 206. It will be appreciated that the digital wallets may be automatically opened without the need for the provision of login details, since the user may already have provided sufficient authentication in order to open the wallet container. In other words, the user having authenticated itself in order to access the wallet container may not need to re-authenticate in order to access a particular digital wallet within the wallet container.

At step 226, one or more payment vehicles are selected from the payment vehicles displayed at step 224. At step 228, the wallet 206 provides the wallet container 204 with details of the selected payment vehicle. The details may include card details and shipping addresses etc.

The at least one server contains the wallet container, and associates the selected payment vehicle and the relevant wallet with the wallet container 204. The at least one server does so in order that the selected payment vehicle is the provisioned into (i.e. added to) the relevant wallet in the wallet container 204. Optionally, the wallet 206 may send confirmation email to the interface 202 at step 230.

The process shown in FIG. 2 illustrates that a wallet container may contain a plurality of wallets each of which is associated with a wallet account. The wallet container may, however, only provide access to a subset of the payment vehicles otherwise registered in each respective wallet account. The workflow shown in FIG. 2 can therefore be used to make additional payment vehicles accessible from the respective digital wallet, through the wallet container.

According to an embodiment of the invention, wallet container supports a network of wallets for web-based checkout and online payment transactions. A consumer can create account for these wallets and load their cards and shipping addresses onto the account. For consumers to use these cards/shipping addresses for in-store and in-app transactions, it is important to support importing/loading of this data from their web wallets to the app. Using the wallet locator, consumers can identify and load one or more wallets at a time into the wallet container and concurrently, or thereafter, import payment vehicles and associated credentials (e.g. shipping addresses) from their existing account into the wallet container app. Thus a wallet of wallets can be created.

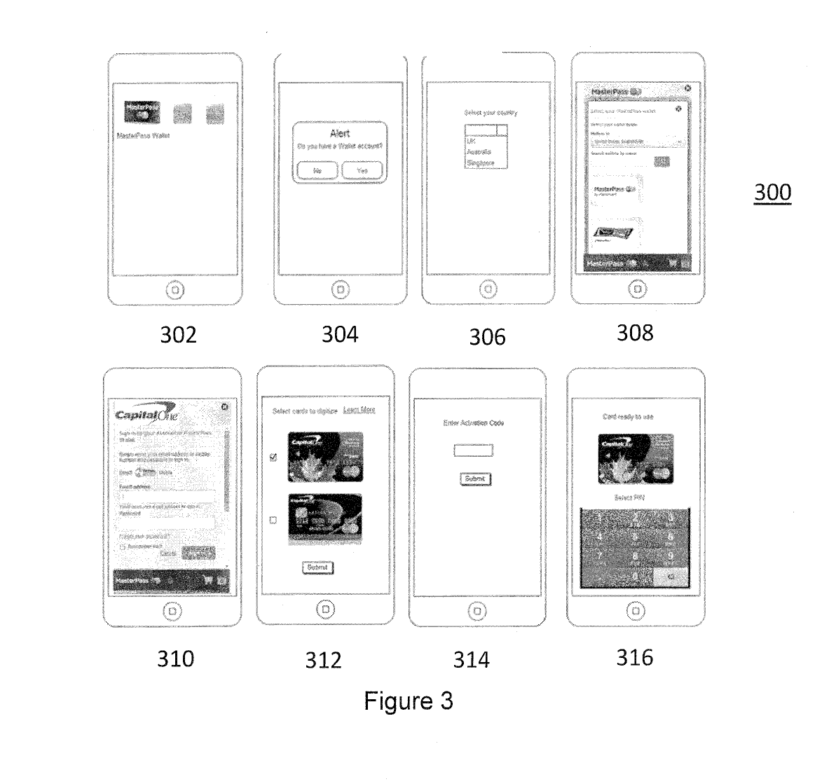

FIG. 3 shows Graphical User Interface (GUI) 300 on a computing device such as a mobile device for a consumer with a wallet account, according to an embodiment of the invention, whereby a payment vehicle (presently a credit card) is made accessible in a wallet contained in the wallet container. Notably, the wallet may already be available from within the wallet container, but the card has yet to be made available for transactions through the wallet container. Similarly, however, where the wallet is not yet containerised in the wallet container, the wallet may be containerised at the same time as the card is made accessible from that wallet, through the wallet container.

At step 302, a wallet container, such as an instance of a MasterPass® Wallet App, is downloaded and opened by the consumer. At step 304, the wallet container produces a dialog box asking if the consumer has a wallet account. In this scenario, the consumer has a wallet account. So YES is selected.

At step 306, the wallet container requests country and/or language information to properly set up the wallet container (e.g. so it is displayed in the relevant language) and/or to enable easier location of related digital wallets by the wallet locator. In an embodiment, a geo-location API may be used to identify the country and/or language. By identifying the country or region in which the mobile device is located, the digital wallets displayed on the mobile device may be only those that are made available in that particular country or region.

At step 308, the wallet container displays one or more wallets to the consumer and receives a selection of a wallet from the displayed one or more wallets. The one or more wallets may include wallets contained in the wallet container and/or wallets not yet contained in the wallet container.

At step 310, the wallet container instructs the selected wallet to display a login page. The selected wallet then displays the login page through which it receives login information from the user. At step 312, the wallet displays one or more cards registered in the wallet. The wallet container then receives a selection of a card by the consumer. Optionally, at step 314, the wallet receives an activation code (e.g. a code sent to the mobile device to confirm that the party attempting to load the card into the wallet container is the holder of the correct mobile device) for the selected card and the wallet validates the user or mobile device. At step 316, the wallet receives a PIN for transactions using the card, from the consumer, and the card is ready to use from the related digital wallet contained in the wallet container, such as a MasterPass® Wallet. These steps can be repeated if the consumer wants to load cards from multiple wallets into the wallet container.

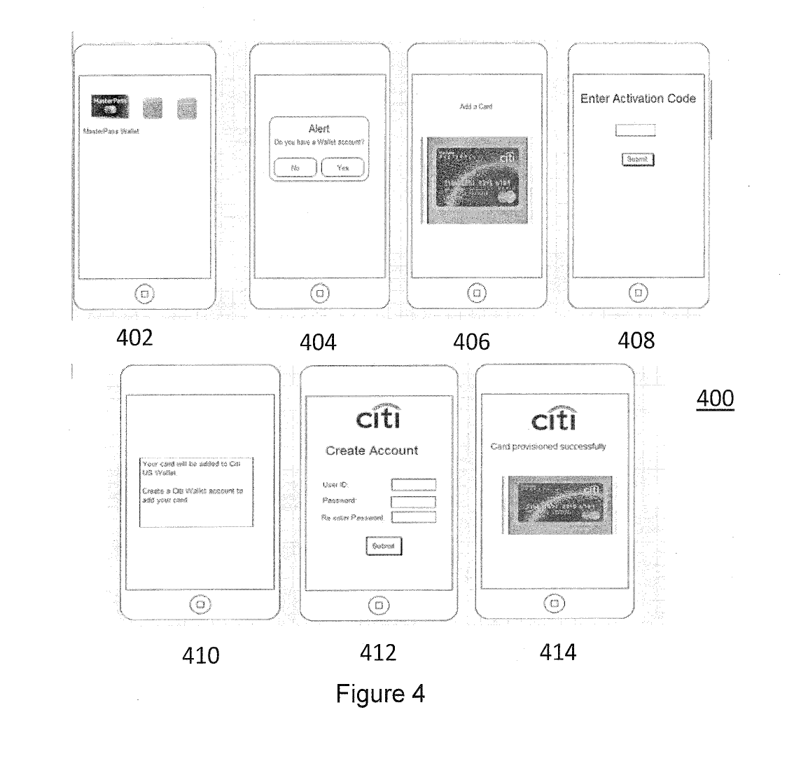

FIG. 4 shows Graphical User Interface (GUI) 400 on a computing device such as a mobile device for a consumer without a wallet account according to an embodiment of the invention. Using the steps shown in FIG. 4, a user may establish a digital wallet (including a digital wallet account) for containerising in the wallet container, and also provision a payment vehicle into the newly containerised digital wallet. At step 402, a wallet container such as MasterPass® Wallet App is downloaded and opened by the consumer. At step 404, the wallet container produces a dialog box asking if the consumer has a wallet account. In this scenario, the consumer does not have any wallet account. So NO is selected. At step 406, a card to be added to the wallet is scanned by a payment vehicle scanner coupled to the mobile device (e.g. a digital camera). An activation code for the scanned card may then be entered to validate the user of the card, at step 408.

At step 410, a digital image of the scanned card is analysed by a digital image analyser on the mobile device to identify credentials of the card and by which a related digital wallet for containing the card can be identified. At step 412, an account of the related digital wallet for the consumer is created—to achieve this, the wallet locator locates the relevant related digital wallet and installs the digital wallet on the mobile device, in the wallet container, or otherwise establishes an appropriate digital wallet account accessible through the wallet container. After creation of the digital wallet account, the scanned card in the digital wallet is made accessible through the wallet container at step 414.

FIG. 5 shows Graphical User Interface (GUI) 500 on a computing device such as a mobile device for executing a checkout process during online shopping according to an embodiment of the invention. At step 502, an acceptance mark 503, such as Buy with MasterPass®, is clicked by a consumer after selection of articles to buy.

In response to selection (by e.g. click or touch) of the acceptance mark, a wallet container displays a plurality of cards from a plurality of wallets at step 504. While all of the payment vehicles may be displayed, they are nevertheless retained in groups conforming to the wallets into which those payment vehicles have been provisioned. At step 506, a card is selected from the displayed cards for use in the current checkout process. At step 508, a PIN code (such as that established at step 316) is entered for validation of the selected card. Once validation is completed, purchase confirmation will be sent to the consumer at step 510. Thus the wallet container provides access to multiple wallets which then supply information to the payment gateway or checkout process in the usual manner for digital wallets.

FIG. 6 shows a schematic of a network-based system 600 for managing digital wallets according to an embodiment of the invention. The system 600 comprises a computer 602, one or more databases 604a . . . 604n, a user input module 606 and a user output module 308. Each of the one or more databases 604a . . . 604n are communicatively coupled with the computer 602. The user input module 606 and a user output module 608 may be separate and distinct modules communicatively coupled with the computer 602. Alternatively, the user input module 606 and a user output module 608 may be integrated within a single mobile electronic device (e.g. a mobile phone, a tablet computer, etc.). The mobile electronic device may have appropriate communication modules for wireless communication with the computer 602 via existing communication protocols.

The computer 602 may comprise: at least one processor; and at least one memory including computer program code; the at least one memory and the computer program code configured to, with at least one processor, cause the computer at least to: (A) provide a wallet container on a computing device, the wallet container being configured to provide access to a plurality of digital wallets through the wallet container and including a transaction receiver, for opening the wallet container upon selection of an acceptance mark in an online payment portal accessible from the computing device, and a wallet locator for automatically identifying digital wallets for containment in the wallet container; (B) identifying one or more digital wallets using the wallet locator; and (C) containerizing the one or more digital wallets into the wallet container such that the one or more digital wallets are accessible through the wallet container.

In an implementation, the computer 602 may be further caused to: (D) scan a payment vehicle using a payment vehicle scanner to create a digital image of the payment vehicle; (E) analyse the digital image of the payment vehicle using a digital image analyser to identify payment vehicle credentials of the payment vehicle; (F) determine one or more payment vehicle credentials contained in the digital image; and (G) identify a related digital wallet for containing the payment vehicle. The computer 302 may be further caused to (H) search an online repository of digital wallets to identify the related digital wallet to contain the payment vehicle, if there is no related digital wallet yet installed on the computing device.

The various types of data, e.g. wallet credentials and payment vehicle credentials, can be stored on a single database (e.g. 604a), or stored in multiple databases (e.g. wallet credentials are stored on database 604a, payment vehicle credentials are stored on database 604n, etc.). The databases 604a . . . 604n may be realized using cloud computing storage modules and/or dedicated servers communicatively coupled with the computer 602.

FIG. 7 depicts an exemplary computer/computing device 700, hereinafter interchangeably referred to as a computer system 700, where one or more such computing devices 700 may be used to facilitate execution of the above-described method for managing a plurality of digital wallets. In addition, one or more components of the computer system 700 may be used to realize the computer 602. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a storage drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive or a memory card), or the like. The removable storage drive 714 reads from and/or writes to a removable storage medium 744 in a well-known manner. The removable storage medium 744 may include magnetic tape, optical disk, non-volatile memory storage medium, or the like, which is read by and written to by removable storage drive 714. As will be appreciated by persons skilled in the relevant art(s), the removable storage medium 744 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 740. Examples of a removable storage unit 722 and interface 740 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 740 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments of the inventions, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port (such as a serial, parallel, printer, GPIB, IEEE 1393, RJ35, USB), an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage medium 744, removable storage unit 722, a hard disk installed in storage drive 712, or a carrier wave carrying software over communication path 726 (wireless link or cable) to communication interface 724. Computer readable storage media refers to any non-transitory, non-volatile tangible storage medium that provides recorded instructions and/or data to the computing device 700 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the storage drive 712, or the interface 740. Alternatively, the computer program product may be downloaded to the computer system 700 over the communications path 726. The software, when executed by the processor 704, causes the computing device 700 to perform functions of embodiments described herein.

It is to be understood that the embodiment of FIG. 7 is presented merely by way of example. Therefore, in some embodiments one or more features of the computing device 700 may be omitted. Also, in some embodiments, one or more features of the computing device 400 may be combined together. Additionally, in some embodiments, one or more features of the computing device 700 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for managing digital wallets, comprising:
providing a wallet container on a computing device, the wallet container being configured to provide access to a plurality of digital wallets through the wallet container, and comprising:
a transaction receiver for opening the wallet container upon selection of an acceptance mark in an online payment portal accessible from the computing device; and
a wallet locator for automatically identifying digital wallets for containment in the wallet container;
identifying one or more digital wallets using the wallet locator; and
containerizing the one or more digital wallets into the wallet container such that the one or more digital wallets are accessible through the wallet container.

2. The method as claimed in claim 1, further comprising performing an update of wallet credentials of one or more wallets from the plurality of wallets contained in the container.

3. The method as claimed in claim 1, further comprising performing a global update of wallet credentials of all digital wallets contained in the container.

4. The method as claimed in claim 1, further comprising scanning a payment vehicle using a payment vehicle scanner to create a digital image of the payment vehicle.

5. The method as claimed in claim 4, further comprising analysing the digital image of the payment vehicle using a digital image analyser to identify payment vehicle credentials of the payment vehicle.

6. The method as claimed in claim 5, further comprising identifying a related digital wallet for containing the payment vehicle.

7. The method as claimed in claim 6, wherein identifying a related digital wallet comprises locating the related digital wallet on the computing device.

8. The method as claimed in claim 6, further identifying a related digital wallet comprises searching an online repository of digital wallets to identify the related digital wallet to contain the payment vehicle.

9. The method as claimed in claim 8, further comprising automatically installing the related digital wallet on the computing device and making the payment vehicle accessible through the related digital wallet.

10. The method as claimed in claim 1, wherein identifying one or more digital wallets using the wallet locator comprises searching the computing device to locate digital wallets installed on the computing device outside the wallet container.

11. A wallet container for making a plurality of digital wallets accessible through the wallet container, the wallet container being configured to be installed on a computing device and comprising:
a transaction receiver for opening the wallet container upon selection of an acceptance mark in an online payment portal accessible from the device; and
a wallet locator for automatically identifying digital wallets for containment in the wallet container.

12. The wallet container as claimed in claim 11, further comprising a containerizer for containerizing wallets identified by the wallet locator so that the identified wallet is accessible through the wallet container.

13. The wallet container as claimed in claim 11, further comprising means for performing a global update of wallet credentials of all digital wallets contained in the wallet container.

14. The wallet container as claimed in claim 11, further comprising means for performing an update of wallet credentials of at least one wallet from the plurality of wallets contained in the wallet container.

15. The wallet container as claimed in claim 11, further comprising a payment vehicle scanner for scanning a payment vehicle to identify payment vehicle credentials of the payment vehicle.

16. The wallet container of claim 15, wherein the payment vehicle scanner creates a digital image of the payment vehicle.

17. The wallet container as claimed in claim 16, wherein the payment vehicle scanner comprises a digital image analyser for analysing the digital image of the payment vehicle to identify payment vehicle credentials of the payment vehicle.

18. The wallet container as claimed in claim 15, further comprising a wallet identifier for identifying a related digital wallet, installed on the computing device, for containing the payment vehicle.

19. The wallet container as claimed in claim 15, further comprising a wallet identifier for searching an online repository of digital wallets to identify a related digital wallet to contain the payment vehicle.

20. A computing device comprising a wallet container as claimed in claim 11.

21. A system for managing digital wallets, comprising a computer, the computer comprising:
at least one processor; and
at least one memory including computer program code;
the at least one memory and the computer program code configured to, with at least one processor, cause the computer at least to:
provide a wallet container on a computing device, the wallet container being configured to provide access to a plurality of digital wallets through the wallet container, and comprising:
a transaction receiver for opening the wallet container upon selection of an acceptance mark in an online payment portal accessible from the computing device; and
a wallet locator for automatically identifying digital wallets for containment in the wallet container;
identify one or more digital wallets using the wallet locator; and
containerize the one or more digital wallets into the wallet container such that the one or more digital wallets are accessible through the wallet container.

22. The system as claimed in claim 21, the system is a mobile device.

23. A computer readable medium including computer program code configured to, with at least one processor, cause a computer at least to:
provide a wallet container on a computing device, the wallet container being configured to provide access to a plurality of digital wallets through the wallet container, and comprising:
a transaction receiver for opening the wallet container upon selection of an acceptance mark in an online payment portal accessible from the computing device; and
a wallet locator for automatically identifying digital wallets for containment in the wallet container;
identify one or more digital wallets using the wallet locator; and
containerize the one or more digital wallets into the wallet container such that the one or more digital wallets are accessible through the wallet container.
